(19) United States
(12) Patent Application Publication
(10) Pub. No.: US 2013/0069493 A1
(43) Pub. Date: Mar. 21, 2013

(54) MOTOR CONTROL DEVICE

(71) Applicant: Hiroshi Ogawa, Aichi (JP)

(72) Inventor: Hiroshi Ogawa, Aichi (JP)

(73) Assignee: OMRON AUTOMOTIVE ELECTRONICS CO., LTD., Aichi (JP)

(21) Appl. No.: 13/618,743

(22) Filed: Sep. 14, 2012

(30) Foreign Application Priority Data
Sep. 16, 2011 (JP) 2011-203525

(51) Int. Cl. H02K 5/22

(52) U.S. Cl. 310/68 D

(57) ABSTRACT

A motor control device has a square metallic board, an electric-motor driving switching element mounted on the metallic board, a printed board disposed above the metallic board, a case that accommodates the metallic board and the printed board, a connection portion disposed on a side surface of the case, perpendicular to the metallic board and the printed board, that connects an electric motor and the switching element, an electric-motor controlling semiconductor element mounted in a square region of the printed board located immediately above the metallic board, a power supply component and a connector mounted outside the square region of the printed board, and a terminal that connects board surfaces of the metallic board and the printed board.

### TECHNICAL FIELD

The present invention relates to a component mounting structure of a motor control device.

### RELATED ART

As disclosed in Japanese Unexamined Patent Publication Nos. 2010-188932, 2003-309384, 2005-212722, and 2010-245174, an ECU (Electronic Control Unit) used in an electrically-assisted power steering system of an automobile can be cited as an example of the motor control device.

The ECU controls drive of a motor that is an example of an electric motor. The ECU includes a motor driving switching element, a motor controlling semiconductor element, a power supply component, a connector, and a motor connection portion.

The switching element is mounted on a metallic board, a case, or a printed board. The motor controlling semiconductor element includes at least a microcomputer and a memory. The semiconductor element and the connector are mounted on the printed board. The power supply component is mounted on the printed board or a resin frame.

The metallic board, the printed board, and the resin frame are accommodated in an inner space, which is formed by combining the case and a cover. The connection portion includes a terminal to which a terminal provided on a motor side is bonded by a screw. The connection portion is provided on a side surface of the case. The above portions are electrically connected to one another.

As disclosed in Japanese Unexamined Patent Publication Nos. 2010-188932 and 2005-212722, the ECU and the motor are attached by screws and electrically connected to each other.

In the ECU, sometimes a motor attaching direction varies depending on specifications of the automobile on which the ECU and the motor are mounted, a placing position, and a peripheral structure. In such cases, it is necessary to change a position in which the connection portion of the ECU is placed. However, with the change of the position of the connection portion, it is necessary to change an inner component or a structure of the ECU, and it is necessary to evaluate new design and function, which results in increases of development man-hour and cost. Despite the identical function, it is like developing a new ECU.

### SUMMARY

One or more embodiments of the present invention provides a motor control device that easily changes the electric-motor attaching direction.

In accordance with one or more embodiments of the invention, a motor control device includes: a square metallic board; an electric-motor driving switching element that is mounted on the metallic board; a printed board that is provided above the metallic board; a case that accommodates both the metallic board and the printed board; a connection portion that is provided on a side surface of the case, which is perpendicular to both the boards, in order to connect an electric motor and the switching element; an electric-motor controlling semiconductor element that is mounted in a square region of the printed board located immediately above the metallic board; a power supply component and a connector that are mounted outside the square region of the printed board; and a terminal that connects board surfaces of the metallic board and the printed board.

In accordance with one or more embodiments of the invention, a motor control device includes: a square metallic board; an electric-motor driving switching element that is mounted on the metallic board; a printed board that is provided above the metallic board; a case that accommodates both the metallic board and the printed board; a connection portion that is provided on a side surface of the case, which is perpendicular to both the boards, in order to connect an electric motor and the switching element; an electric-motor controlling semiconductor element that is mounted in a square region of the printed board located immediately above the metallic board; a connector that is mounted outside the square region of the printed board; a terminal that connects board surfaces of the metallic board and the printed board; a resin frame that is provided between the metallic board and the printed board; and a power supply component that is provided in the resin frame.

According to the above configuration, when the electric-motor attaching direction is changed, the positions in which the connection portion, the metallic board, and the terminal are placed with respect to the case may be rotated in parallel with the metallic board. The semiconductor element and the mounting layout in the square region of the printed board may be rotated in parallel with the printed board. Therefore, the electric-motor attaching direction can easily be changed.

In the above motor control device, the electric-motor controlling semiconductor element may include at least a microcomputer.

In the above motor control device, the power supply component may include at least a coil.

According to one or more embodiments of the invention, the motor control device that easily changes the electric-motor attaching direction can be provided.

### BRIEF DESCRIPTION OF THE DRAWINGS

FIG. 1 is an exploded perspective view of a motor control device according to one or more embodiments of the invention;

FIG. 2 is an exploded perspective view of the motor control device in FIG. 1 when viewed from another angle;

FIG. 3 is a front view of the motor control device in FIG. 1;

FIG. 4 is a side view of the motor control device in FIG. 1;

FIG. 5 is a bottom view of the motor control device in FIG. 1;

FIG. 6 is a sectional view of the motor control device in FIG. 1;

FIG. 7 is a view illustrating a metallic board in the motor control device in FIG. 1;

FIG. 8 is a view illustrating a printed board in the motor control device in FIG. 1;

FIG. 9 is a view illustrating a state in which the motor control device in FIG. 1 and an electric motor are attached;

FIG. 10 is a view illustrating the metallic board in the motor control device when an electric-motor attaching direction is changed counterclockwise by 90°;

FIG. 11 is a view illustrating the printed board in the motor control device when the electric-motor attaching direction is changed counterclockwise by 90°;

FIG. 12 is a view illustrating the state, in which the motor control device and the electric motor are attached, when the electric-motor attaching direction is changed counterclockwise by 90°;

FIG. 13 is a view illustrating the metallic board in the motor control device when the electric-motor attaching direction is changed clockwise by 90°;

FIG. 14 is a view illustrating the printed board in the motor control device when the electric-motor attaching direction is changed clockwise by 90°;

FIG. 15 is a view illustrating the state, in which the motor control device and the electric motor are attached, when the electric-motor attaching direction is changed clockwise by 90°; and

FIG. 16 is an exploded perspective view of an inside of a motor control device according to one or more embodiments of the present invention.

### DETAILED DESCRIPTION

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. In the following drawings, the identical or equivalent portion is designated by the identical numeral.

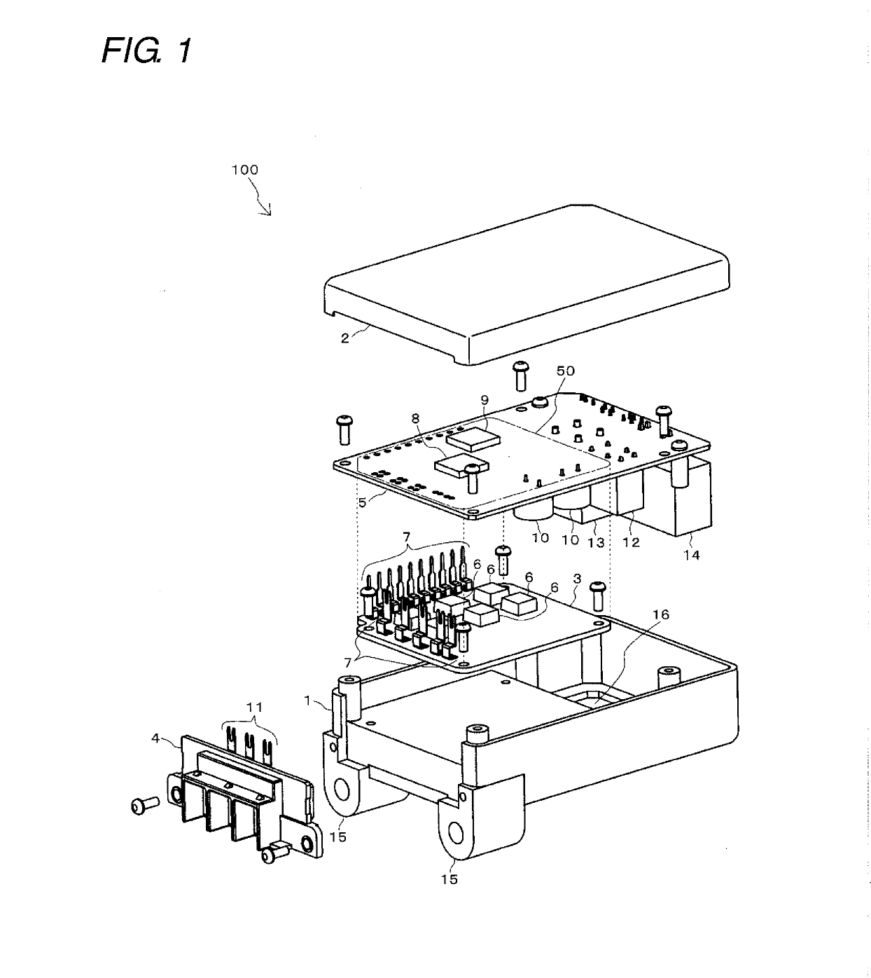

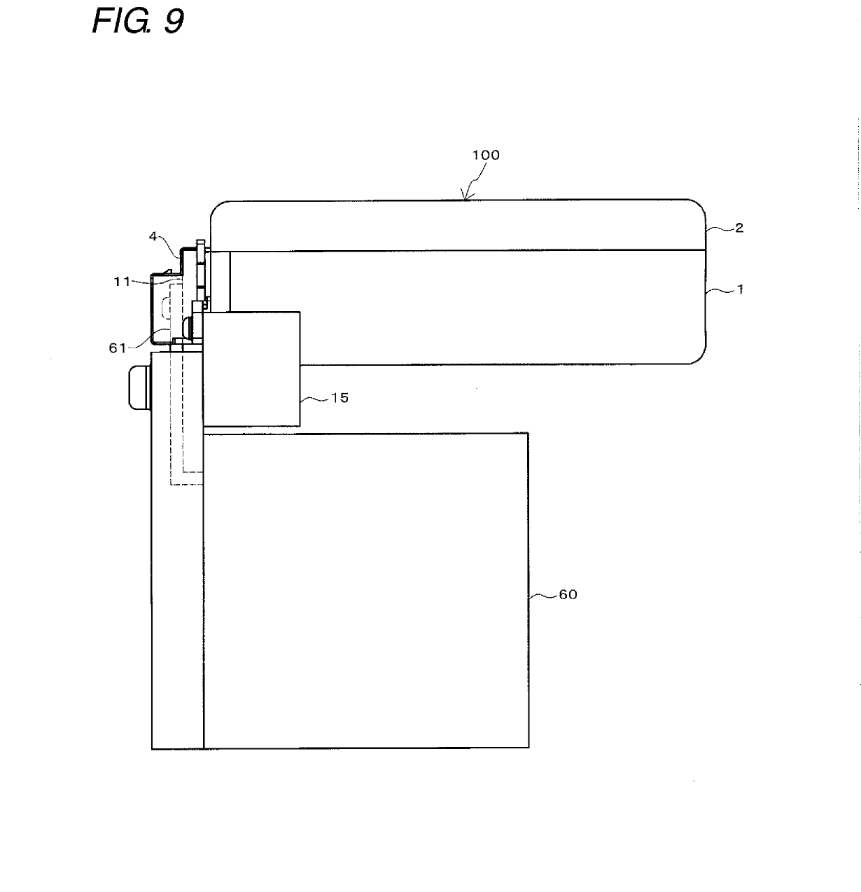

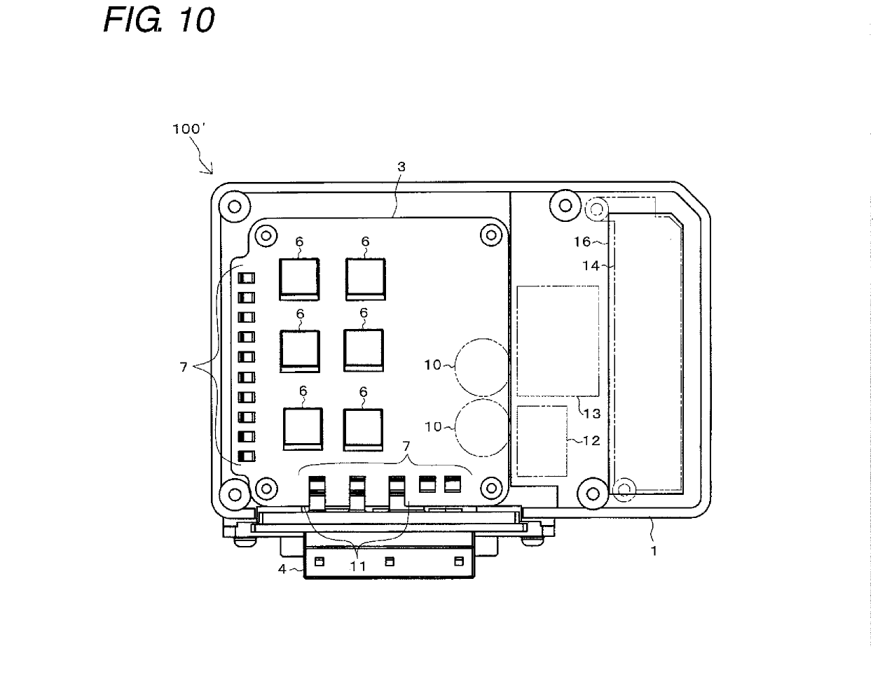

FIGS. 1 to 9 illustrate a motor control device 100 according to one or more embodiments of the invention. The motor control device 100 is an ECU (Electronic Control Unit) used in an electrically-assisted power steering system of an automobile. The motor control device 100 controls drive of an electric motor 60 (FIG. 9) including a motor.

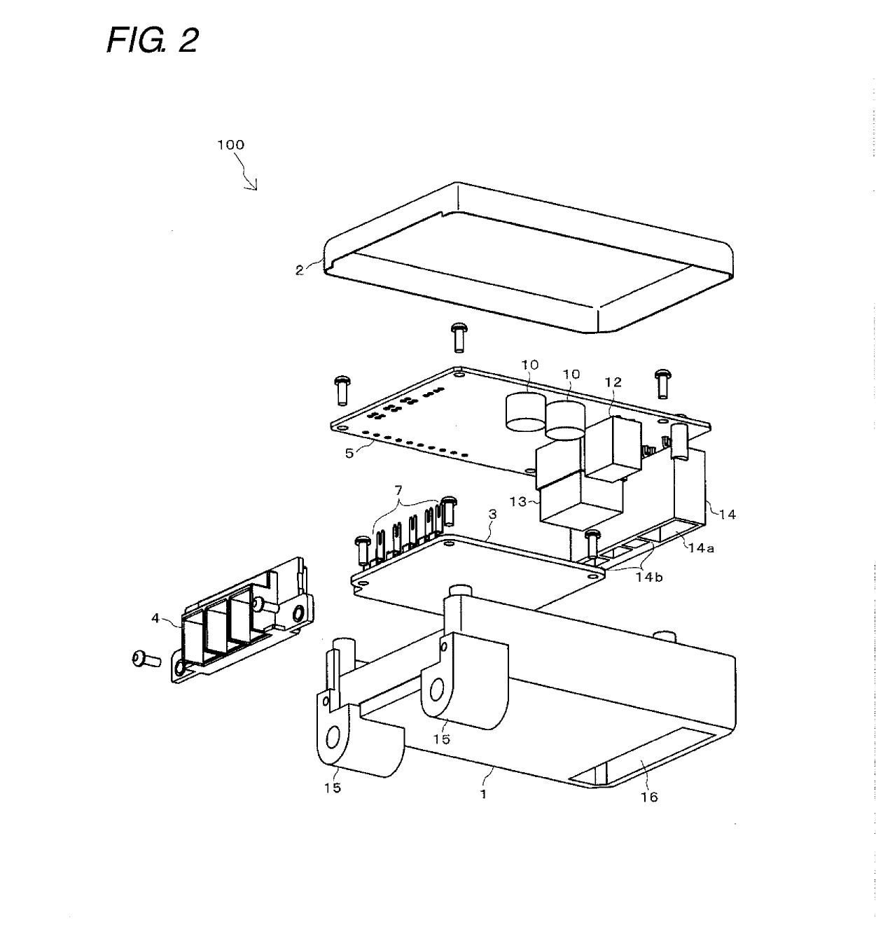

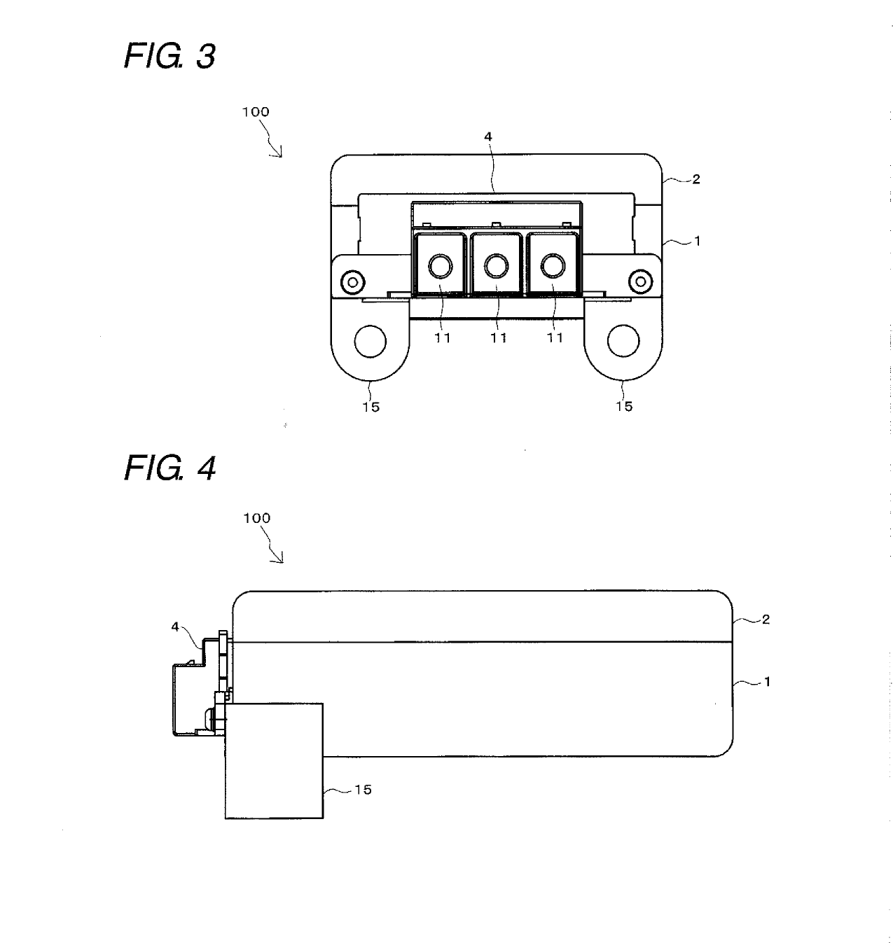

As illustrated in FIGS. 1 and 2, the motor control device 100 includes a case 1, a cover 2, a metallic board 3, a connection portion 4, and a printed board 5. As illustrated in FIGS. 6 to 8, the case 1 accommodates the metallic board 3 and the printed board 5. As illustrated in FIGS. 3 and 4, the cover 2 covers an upper side of the case 1. The case 1 and the cover 2 are fitted in each other by a well-known lock structure (not illustrated).

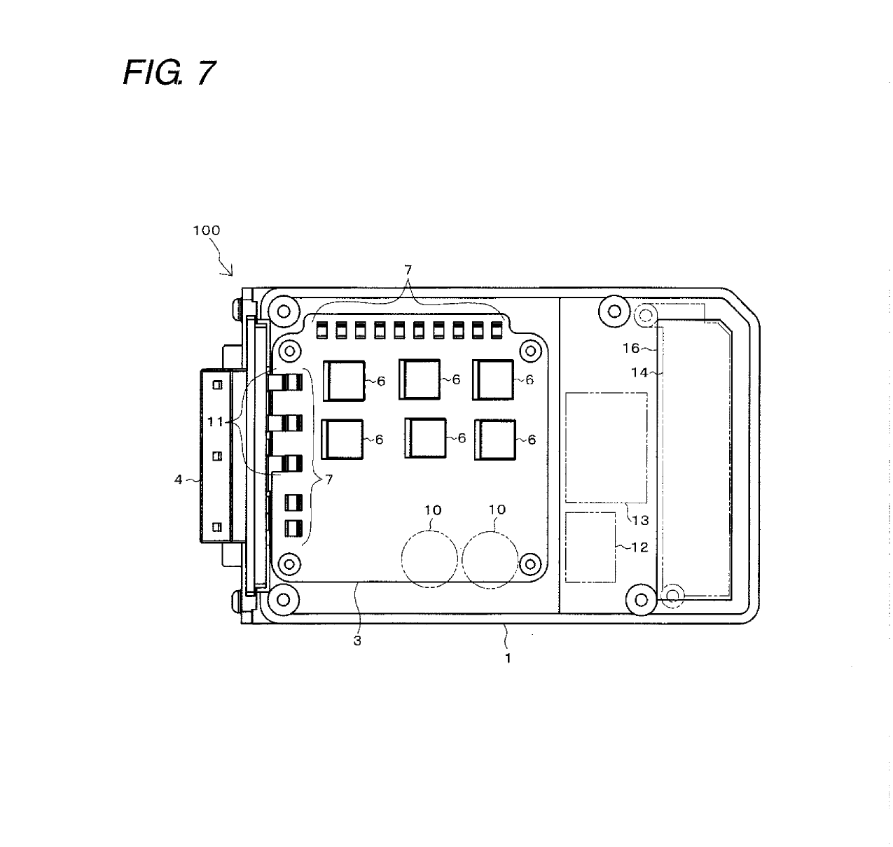

As illustrated in FIG. 7, the metallic board 3 is formed into a substantially square shape. Plural switching elements 6 are mounted near a center of the metallic board 3 in order to drive the electric motor 60. For example, the switching element 6 includes an FET (Field Effect Transistor). As illustrated in FIGS. 6 and 7, the metallic board 3 is screwed in the case 1.

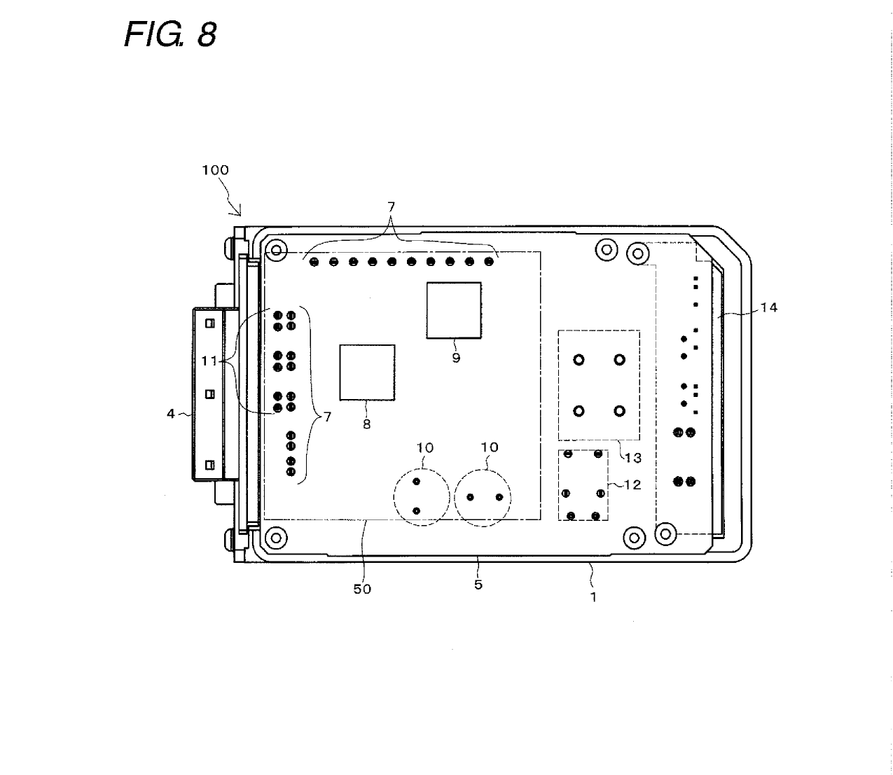

As illustrated in FIGS. 1, 2, and 7, plural terminals 7 are mounted in an end portion of the metallic board 3. Leading ends of the terminals 7 are mounted on the printed board 5 by soldering. Therefore, as illustrated in FIG. 6, the terminals 7 connect board surfaces of the metallic board 3 and the printed board 5. The printed board 5 is provided above the metallic board 3 in parallel with the metallic board 3. As illustrated in FIGS. 6 and 8, the printed board 5 is screwed in the case 1.

The connection portion 4 is provided in one of side surfaces of the case 1, which are perpendicular to the boards 3 and 5. Particularly, the connection portion 4 is screwed in one of side surface in a crosswise direction of the case 1. As illustrated in FIG. 3, three terminals 11 are provided in the connection portion 4. As illustrated in FIG. 9, a leading end of a terminal 61 provided in an electric motor 60 is screwed in the terminal 11.

As illustrated in FIG. 1, the leading ends of the terminals 11 project from an upper end of the connection portion 4. As illustrated in FIG. 6, the leading ends of the terminals 11 are mounted on the printed board 5 by soldering. Therefore, the connection portion 4 connects the electric motor 60 and the switching element 6 through the boards 3 and 5 and the terminals 7, 11, and 61. As illustrated in FIG. 9, the electric motor 60 is screwed in a fixing portion 15 provided in a bottom of the case 1.

As illustrated in FIGS. 1 and 8, in order to control the drive of the electric motor 60, semiconductor elements 8 and 9 are mounted in a square region 50 of the printed board 5 located immediately above the metallic board 3. The terminals 7 and 11, a capacitor 10, and other electronic components (not illustrated) are also mounted in the region 50.

The semiconductor elements 8 and 9 include at least a microcomputer. In one or more embodiments, the semiconductor element 8 is a main control microcomputer. The semiconductor element 9 is a driver that switches ON and OFF of the switching element 6. Additionally, semiconductor elements, such as a memory and an ASIC, may be provided in the square region 50.

Power supply components 12 and 13 and a connector 14 are mounted outside the square region 50 of the printed board 5. The power supply components 12 and 13 include at least a coil. In one or more embodiments, the power supply component 12 is the coil. The power supply component 13 is a relay. Mounting profiles of the power supply components 12 and 13 are higher than those of other electronic components.

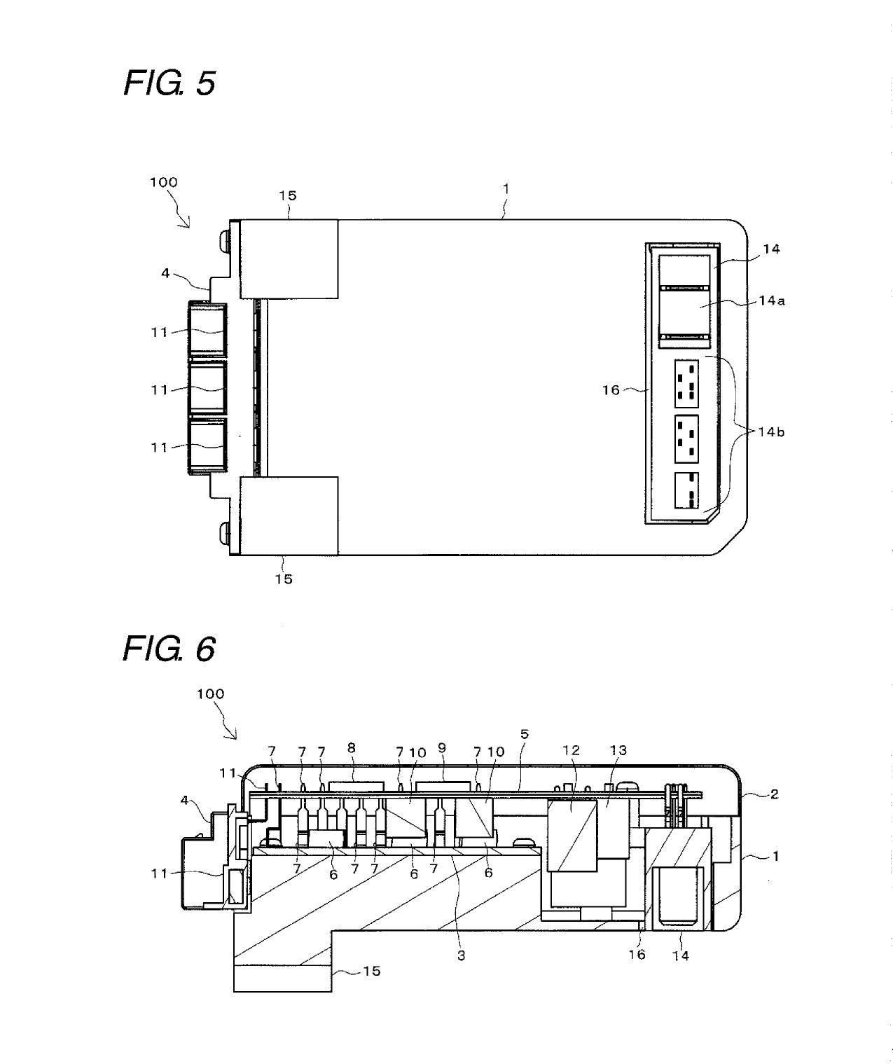

As illustrated in FIGS. 2 and 5, a power feeding outlet 14a and a communication outlet 14b are provided in the connector 14. The outlets 14a and 14b of the connector 14 are accessed through an opening 16 provided in the bottom of the case 1. As illustrated in FIGS. 1, 2, and 6, the connector 14 is screwed in the printed board 5.

The change of the attaching direction of the electric motor 60 in the motor control device 100 will be described below.

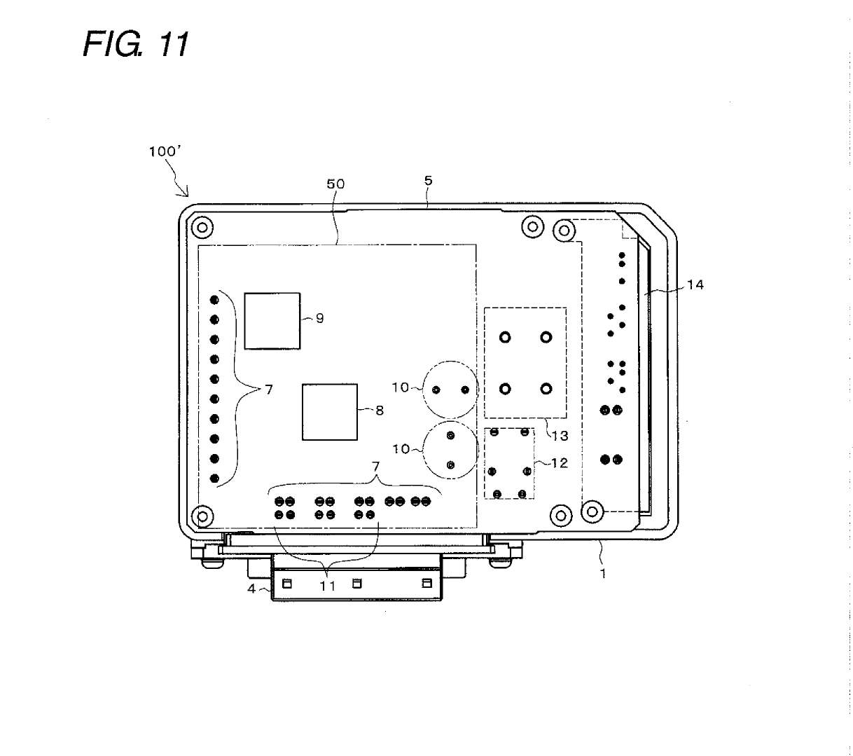

FIGS. 10 to 12 illustrate an example of a motor control device in which the attaching direction of the electric motor 60 is changed. In a motor control device 100′, as comparing with the motor control device 100 (see FIGS. 7 to 9), the positions in which the connection portion 4, the metallic board 3, and the fixing portion 15 are placed with respect to the case 1 are rotated counterclockwise by 90° in parallel with the metallic board 3. With the rotations of the positions, the positions of the terminals 7 and the capacitor 10 are also rotated counterclockwise by 90° in parallel with the metallic board 3.

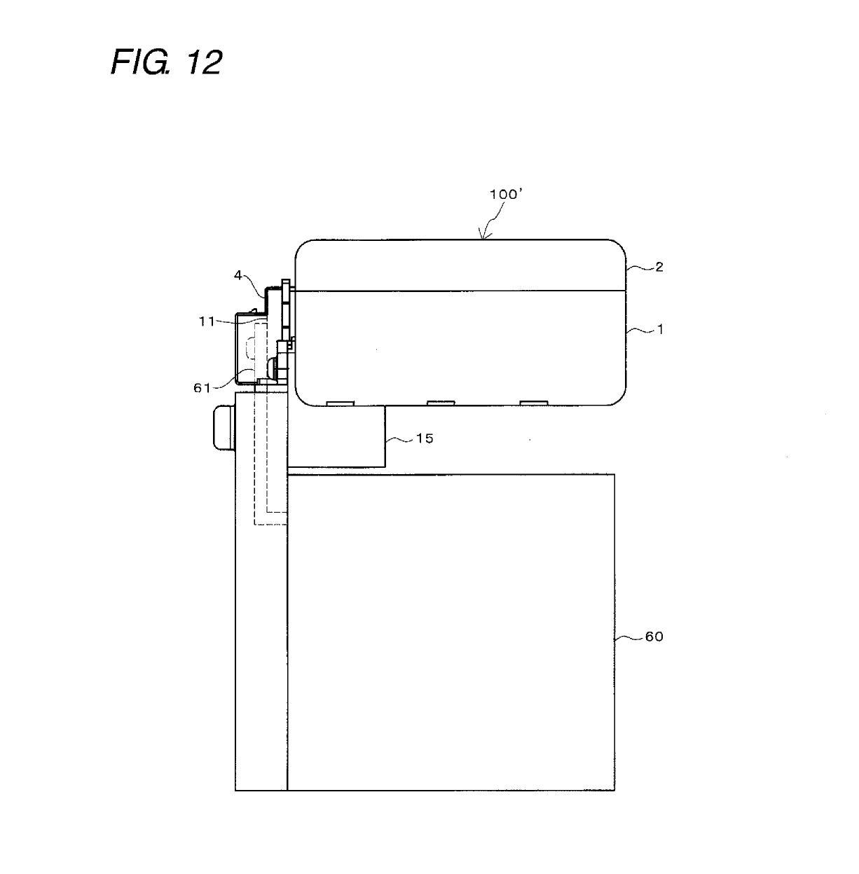

The semiconductor elements 8 and 9 and the mounting layout in the square region 50 of the printed board 5 are rotated counterclockwise by 90° in parallel with the printed board 5. Therefore, the electric motor 60 is attached to the motor control device 100′ while rotated counterclockwise by 90° in parallel with the boards 3 and 5 (see FIGS. 9 and 12).

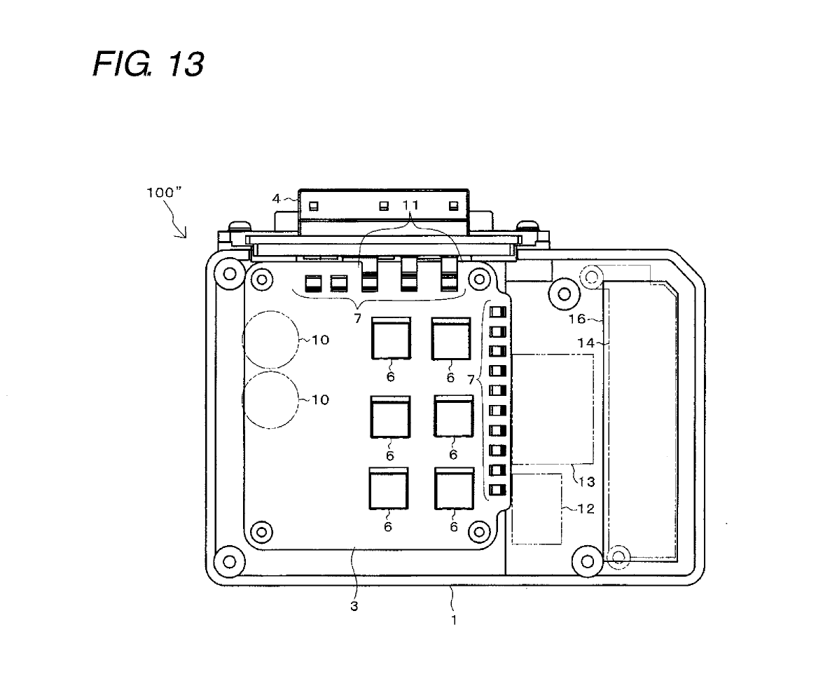

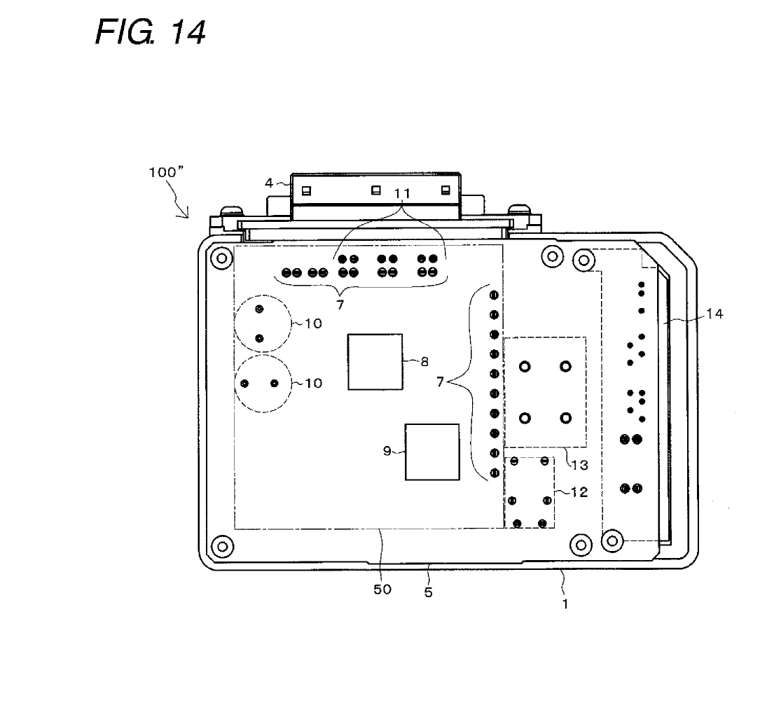

FIGS. 13 to 15 illustrate another example of a motor control device in which the attaching direction of the electric motor 60 is changed. In a motor control device 100″, as comparing with the motor control device 100 (see FIGS. 7 to 9), the positions in which the connection portion 4, the metallic board 3, and the fixing portion 15 are placed with respect to the case 1 are rotated clockwise by 90° in parallel with the metallic board 3. With the rotations of the positions, the positions of the terminals 7 and the capacitor 10 are also rotated clockwise by 90° in parallel with the metallic board 3.

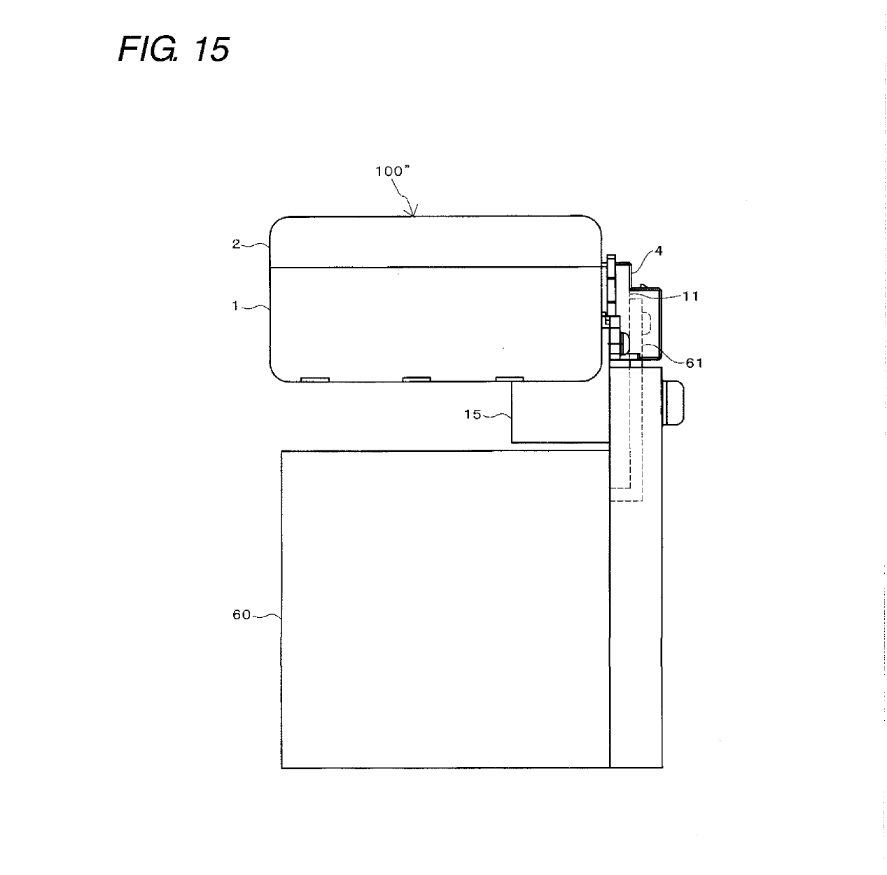

The semiconductor elements 8 and 9 and the mounting layout in the square region 50 of the printed board 5 are rotated clockwise by 90° in parallel with the printed board 5. Therefore, the electric motor 60 is attached to the motor control device 100″ while rotated clockwise by 90° in parallel with the boards 3 and 5 (see FIGS. 9 and 15).

According to one or more embodiments, when the attaching direction of the electric motor 60 is changed, the positions in which the connection portion 4, the metallic board 3, the terminals 7, and the fixing portion 15 are placed with respect to the case 1 may be rotated in parallel with the metallic board 3. The semiconductor elements 8 and 9 and the mounting layout in the square region 50 of the printed board 5 may be rotated in parallel with the printed board 5. Therefore, the attaching direction of the electric motor 60 can easily be changed.

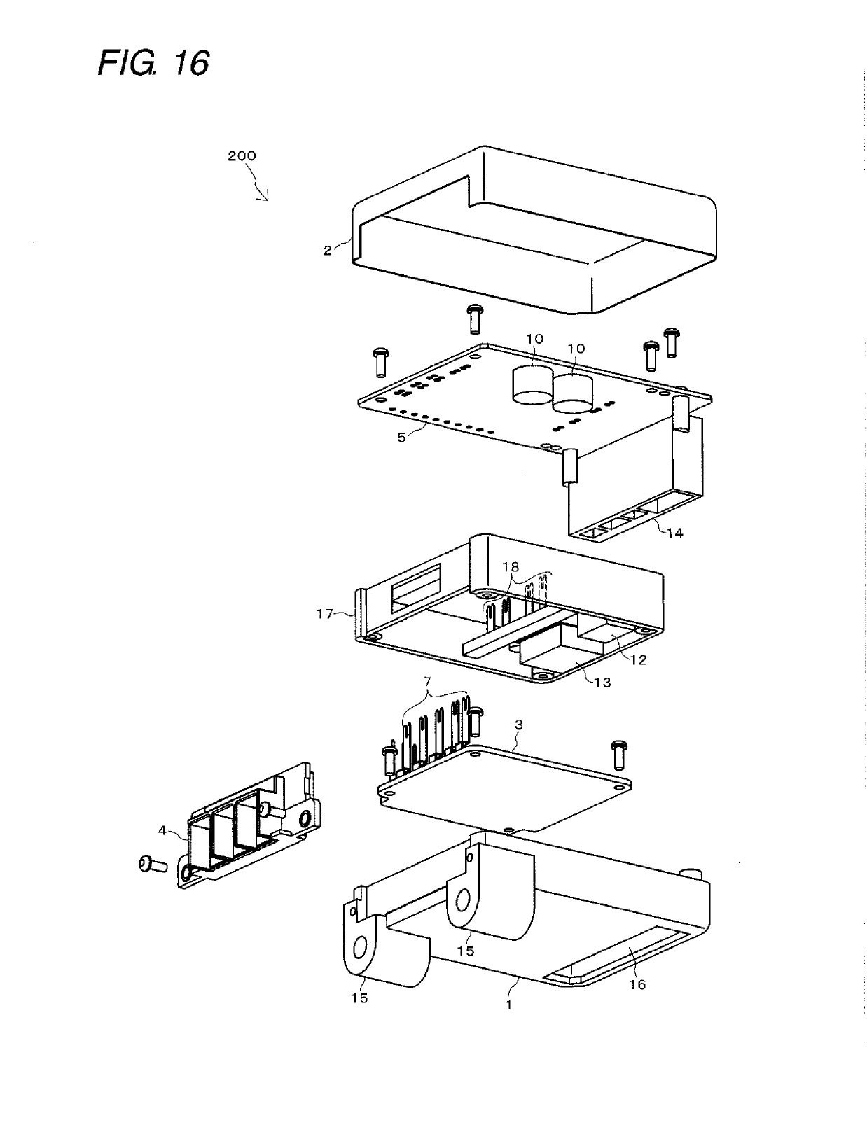

In addition to the above embodiments, various embodiments can be adopted in the invention. For example, in one or more of the above embodiments, the power supply components 12 and 13 are provided on the printed board 5 by way of example, but the present invention is not limited thereto. Alternatively, for example, as illustrated in FIG. 16, a resin frame 17 is provided between the metallic board 3 and the printed board 5, and the power supply components 12 and 13 may be provided in the resin frame 17. In the case of a motor control device 200 in FIG. 16, for example, terminals 18 connected to the power supply components 12 and 13 are provided in the resin frame 17, and the terminals 18 may be connected to the printed board 5.

In one or more of the above embodiments, the terminals 11 of the connection portion 4 are connected to the printed board 5 by way of example, but the present invention is not limited thereto. Alternatively, for example, the terminals 11 of the connection portion 4 may be connected to the metallic board 3. Therefore, the electric motor 60 and the switching element 6 are electrically connected.

Above, by way of example, one or more embodiments of the invention is applied to the motor control device 100 used in the electrically-assisted power steering system. Alternatively, one or more embodiments of the invention can also be applied to other motor control devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A motor control device comprising:
a square metallic board;
an electric-motor driving switching element that mounted on the metallic board;
a printed board disposed above the metallic board;
a case that accommodates both the metallic board and the printed board;
a connection portion disposed on a side surface of the case, perpendicular to the metallic board and the printed board that connects an electric motor and the switching element;
an electric-motor controlling semiconductor element mounted in a square region of the printed board located immediately above the metallic board;
a power supply component and a connector mounted outside the square region of the printed board; and
a terminal that connects board surfaces of the metallic board and the printed board.

2. A motor control device comprising:
a square metallic board;
an electric-motor driving switching element mounted on the metallic board;
a printed board disposed above the metallic board;
a case that accommodates the metallic board and the printed board;
a connection portion disposed on a side surface of the case, perpendicular to the metallic board and the printed board that connects an electric motor and the switching element;
an electric-motor controlling semiconductor element mounted in a square region of the printed board located immediately above the metallic board;
a connector mounted outside the square region of the printed board;
a terminal that connects board surfaces of the metallic board and the printed board;
a resin frame disposed between the metallic board and the printed board; and
a power supply component disposed in the resin frame.

3. The motor control device according to claim 1, wherein the electric-motor controlling semiconductor element includes at least a microcomputer.

4. The motor control device as in claim 1, wherein the power supply component includes at least a coil.

5. The motor control device according to claim 2, wherein the electric-motor controlling semiconductor element includes at least a microcomputer.

6. The motor control device as in claim 2, wherein the power supply component includes at least a coil.

7. The motor control device as in claim 3, wherein the power supply component includes at least a coil.

8. The motor control device as in claim 5, wherein the power supply component includes at least a coil.
